(19) United States
(12) Patent Application Publication
(10) Pub. No.: US 2008/0127795 A1
(43) Pub. Date: Jun. 5, 2008

(54) Electric cutting tool

(75) Inventor: Masatoshi Fukinuki, Nanjing (CN)

Correspondence Address: MCDERMOTT, WILL & EMERY LLP, 227 WEST MONROE STREET, SUITE 4400, CHICAGO, IL, 60606-5096, US

(73) Assignee: Chervon Limited

(21) Appl. No.: 11/974,117

(22) Filed: Oct. 11, 2007

(30) Foreign Application Priority Data
Oct. 18, 2006 (CN) CN 200620126464.8

(51) Int. Cl. B26D 7/26; B26D 7/22; B26D 3/02; H02K 7/00

(52) U.S. Cl. 83/471.3; 83/478; 83/581; 318/15

(57) ABSTRACT

An electric cutting tool useful for bevel cutting, the tool having a base adapted to contact a workpiece, a saw unit supported on the base, and a handle mounted on a guard of the saw unit. The saw unit includes a guard, a saw blade disposed within the guard, and a driving motor portion coupled to the saw blade via a transmission mechanism. The driving motor portion includes at least two driving motors, and the output shafts of which are coupled to an input portion of the transmission mechanism. An output portion of the transmission mechanism is coupled to a shaft of the saw blade.

### CROSS-REFERENCE TO RELATED APPLICATION

This application claims priority under 35 U.S.C. 119 to CN 200620126464.8 filed Oct. 18, 2006, and is hereby incorporated by reference.

### FIELD OF THE INVENTION

The present invention relates to an electric cutting tool, and more particularly, it relates to an improved driving mechanism of the electric cutting tool.

### BACKGROUND OF THE INVENTION

The electric cutting tool is one of the most common used electric power tools. With reference to FIGS. 1 and 2, prior art electric cutting tools typically comprise a base 7 adapted to lie on a workpiece during the cutting operation, a saw unit supported on the base 7, and a handle 2 mounted on a guard 5 of the saw unit. Generally, the saw unit comprises the guard 5, a saw blade 6 disposed in the guard 5, and a driving motor 3 coupled to the saw blade 6 via a transmission mechanism 4. To facilitate operation, the driving motor 3 is usually disposed between the saw blade 6 and the handle 5, and is adjacent to the guard 5. However, in order to satisfy the cutting power, typically, the driving motor 3 is of a relatively large size, occupying a lot of space.

In connection with the above described electric cutting tools, the mid-section of the handle 5 and the saw blade 6 are substantially in the same plane, and therefore, the force applied by the operator and the counterforce produced by the workpiece are theoretically in the same plane. Thus, the operator can control the electric cutting tool easily and effectively. However, during bevel cutting, the large size of the driving motor 3 can interfere. As the saw unit of the electric cutting tool is supported on the base 7 through a bevel adjusting means, when it is desired to be adjusted to 45° or other maximum bevel angles, the driving motor can interfere with the surface of the workpiece, and be difficult to handle.

In order to solve the problem, the handle is usually designed to deviate from the plane of the saw blade toward the direction of the driving motor. In such a way, the position of the bevel adjusting means may be moved accordingly such that the problem of the interference between the driving motor and the surface of the workpiece could be solved. However, this adjustment may bring a new issue in that it is not easy to control the cutting tool because the applied force and the counter force produced by the workpiece are not coplanar.

### SUMMARY OF THE INVENTION

An object of the present invention is to overcome the disadvantages in the prior art, and to provide an improved electric cutting tool which can avoid the interference between the driving motor and the workpiece during bevel cutting operation.

The electric cutting tool according to the present invention comprises a base adapted to lie on a surface of a workpiece during cutting, a saw unit, which is supported on the base via a bevel adjusting means, the saw unit comprising a guard, a saw blade disposed within the guard and a driving motor portion coupled to the saw blade via a transmission mechanism, a handle mounted on the guard of the saw unit, wherein the driving motor portion comprises at least two motors which are arranged close to each other between the blade and the handle and along the outer circumference of the saw blade, each of the at least two motors comprises an output shaft which is coupled to an input portion of the transmission mechanism, and an output portion of the transmission mechanism is coupled to a shaft of the saw blade.

With the above-mentioned structure, the requirement of the driving power would be satisfied as long as the sum of the output power of the lower-power motors is equal to the desired output power. As each lower-power motor is smaller than the original single motor in size, and the lower-power motors are arranged around the outer circumference of the saw blade, the axial length of the driving motor portion is reduced greatly. Therefore, the interference between the driving motor portion and the workpiece will not happen when the saw unit is tilted to a relatively large angle, even if the mid-section of the handle is coplanar with the saw blade. Therefore the operation of the electric cutting tool becomes much easier. Furthermore, the arrangement of the lower-power motors reduces the size of the saw unit in the radial direction, such that the electric cutting tool is more compact and the operation with the handle becomes more comfortable.

### BRIEF DESCRIPTION OF THE DRAWINGS

The present invention will become apparent from the following detailed description of the preferred embodiment of the invention illustrated in the accompanying drawings, wherein:

FIG. 1 is a schematic view of a prior art circular saw with a single driving motor;

FIG. 2 is a side view of the circular saw in FIG. 1; wherein the circular saw is in a bevel cutting position;

FIG. 3 is a schematic view of a circular saw according to the present invention;

FIG. 4 is a side view of the circular saw in FIG. 3; wherein the circular saw is in a bevel cutting position.

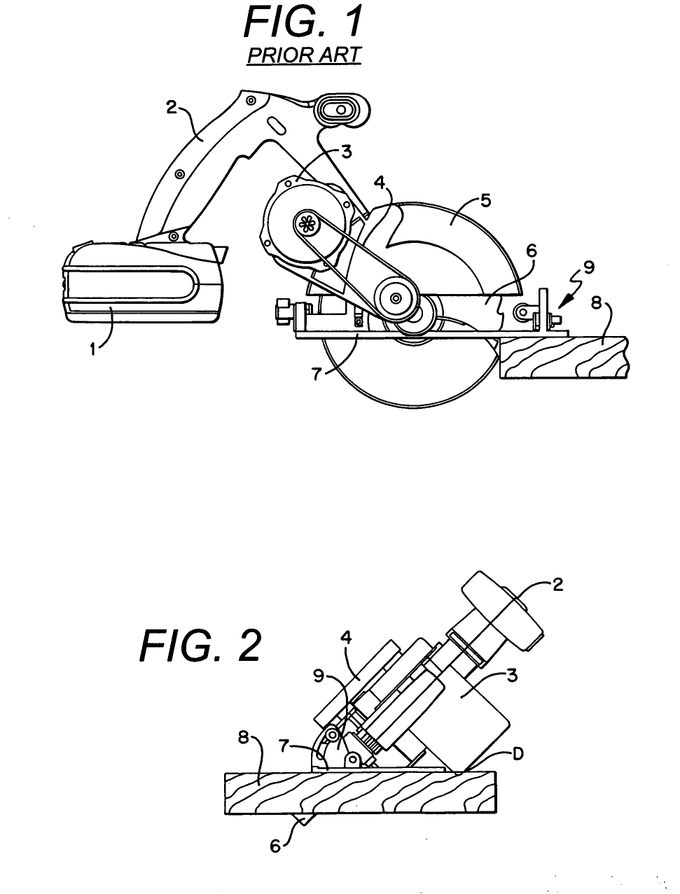

### DETAILED DESCRIPTION OF THE PREFERRED EMBODIMENT

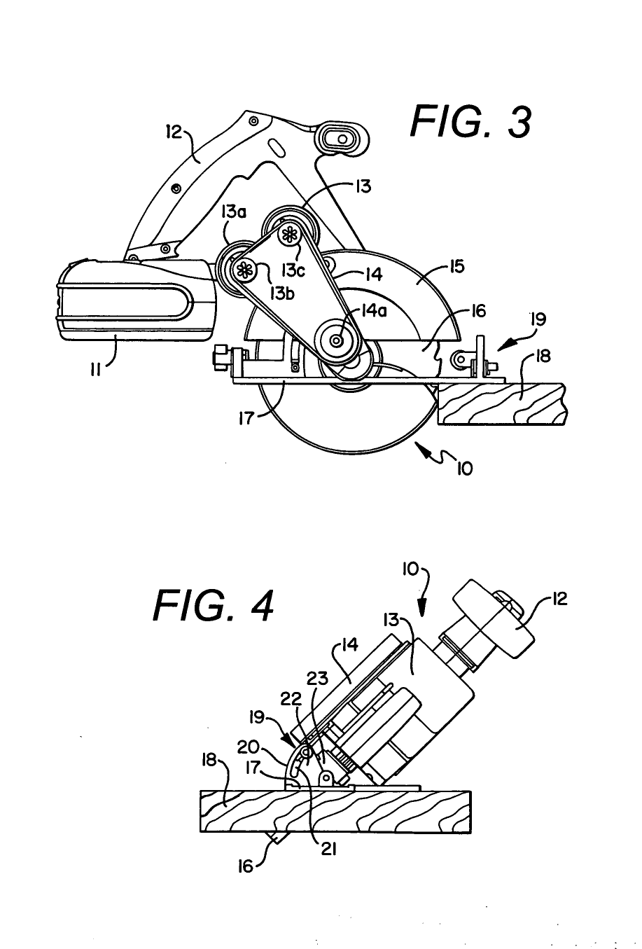

With reference to FIG. 3, the present invention provides an electric circular saw with a battery 11. A base 17 is adapted to contact the surface of a workpiece 18 during cutting. A saw unit is supported on the base 17 via a bevel adjusting means 19. A handle 12 fixedly connected to a guard 15 of the saw unit. The saw unit 10 comprises the guard 15, a saw blade 16 disposed within the guard 15, and a driving motor portion coupled to the saw blade 16 via a belt transmission mechanism. The driving motor portion comprises two driving motors 13 and 13a, which are arranged around the outer circumference of the saw blade 16 and between the saw blade and the handle 12. The two driving motors 13 and 13a each have output shafts, which are parallel to each other and are connected to an input portion of the belt transmission mechanism. Specifically, the output shafts of the two driving motors 13 and 13a are connected to a belt 14 through two wheels 13b and 13c mounted therewith. The belt transmission mechanism is subsequently connected to a shaft 14a of the saw blade 16 via a gear mechanism.

FIG. 4 shows the detailed structure of the bevel adjusting means 19. A guiding plate 20 with an arc-shaped slot 21 is fixedly connected to the base 17, and there is a shaft 22 arranged in the center of the arc-shaped slot. The saw unit 10 is pivotally mounted on the shaft 22. There is a locking member 23 mounted on the saw unit which is movable along the arc-shaped slot.

Before a bevel cutting, the locking member 23 is released, and then the saw unit can be pivoted about the shaft 22. After the saw unit 10 is adjusted to a desired bevel angle, the locking member 23 is tightened to lock the saw unit in the position.

With the two driving motors 13 and 13a in the present invention, the cutting power of the electric cutting tool is sufficient. Since the size of each of the two driving motors 13 and 13a is less than a single driving motor, the length of the driving motor portion is greatly reduced permitting the handle 12 to be configured in a desired position, such as a position where the mid-section of the handle and the saw blade 16 are in the same plane. Thereby, during bevel cutting as shown in FIG. 4, interference between the driving motor portion and the workpiece is avoided, even when the saw unit is adjusted to the maximum bevel angle. Moreover, because the two driving motors 13 and 13a are arranged around the outer circumference of the saw 16, size of the saw unit is reduced in its radial direction. Thus, the electric cutting tool is more compact, and the handle 12 could be much closer to the saw unit, which makes operation more comfortable.

The present invention is not restricted as the embodiments disclosed hereinabove. Any substitutes and modifications according to the spirit of the present invention will be regarded as fall within the appended claims of the present invention.

We claim:

1. An electric cutting tool comprising:
a base adapted to lie on a surface of a workpiece;
a saw unit supported on the base via a bevel adjusting means, the saw unit comprising:
a guard,
a saw blade disposed within the guard, and
a driving motor portion coupled to the saw blade via a transmission mechanism;
a handle mounted on the guard;
wherein the driving motor portion comprises at least two driving motors arranged along an outer circumference of the saw blade, the at least two driving motors each comprising output shafts which are coupled to an input portion of the transmission mechanism, and an output portion of the transmission mechanism coupled to a shaft of the saw blade.

2. The electric cutting tool of claim 1, wherein the two driving motors are disposed between the saw blade and the handle, adjacent to the guard, and the output shafts are parallel to each other.

3. The electric cutting tool of claim 1, wherein the transmission mechanism includes a belt and a gear mechanism.

4. The electric cutting tool of claim 1, further comprising a guiding plate with an arc-shaped slot fixedly connected to the base, a shaft arranged in the center of the arc-shaped slot with the saw unit pivotally mounted thereto, and a locking member mounted to the saw unit and is movable along the arc-shaped slot.

5. An electric cutting tool comprising:
a base contacting a surface of a workpiece;
a saw unit having a guard, the saw unit supported on the base through a bevel adjusting means;
a saw blade disposed within the guard; and
at least two driving motors coupled to the saw blade via a transmission mechanism.

6. The electric cutting tool of claim 5, wherein the bevel adjusting means comprises:
a guiding plate having an arc shaped slot;
a shaft disposed within the slot for pivotally mounting the saw unit; and
a locking member movable along the slot for releasing and locking the saw unit into the desire position for bevel cutting.

7. The electric cutting tool of claim 5, wherein the two driving motors are arranged along an outer circumference of the saw blade.

8. The electric cutting tool of claim 5, wherein the driving motors further comprise output shafts which are coupled to an input portion of the transmission mechanism, and an output portion of the transmission mechanism is coupled to a shaft of the saw blade.

9. The electric cutting tool of claim 5, wherein the two driving motors are disposed between the saw blade and a handle, adjacent to the guard, and the output shafts are parallel to each other.
